(19) United States
(12) Patent Application Publication
(10) Pub. No.: US 2026/0245400 A1
(43) Pub. Date: Aug. 20, 2026

(54) FACE SCORING MODEL TRAINING METHOD, FACE SCORING METHOD, AND RELATED DEVICES

(71) Applicant: WUYI UNIVERSITY, Jiangmen (CN)

(72) Inventors: Junying GAN, Jiangmen (CN); Zhenxin ZHUANG, Jiangmen (CN); Zhen CHEN, Jiangmen (CN); Wenchao XU, Jiangmen (CN); Hantian CHEN, Jiangmen (CN); Huicong LI, Jiangmen (CN); Junling XIONG, Jiangmen (CN); Jianqiang LIU, Jiangmen (CN)

(21) Appl. No.: 19/164,329

(22) PCT Filed: Oct. 21, 2024
(86) PCT No.: PCT/CN2024/126219

§ 371 Date: Sep. 11, 2025

(30) Foreign Application Priority Data
Aug. 30, 2024 (CN) 202411207532.2

(51) Int. Cl. G06V 40/16; G06V 10/82

(52) U.S. Cl. CPC G06V 40/172; G06V 10/82

(57) ABSTRACT

A face scoring model training method, a face scoring method, and related devices are disclosed. The training method includes generating pseudo-labels based on first images annotated with scoring labels, and assigning the pseudo-labels to second images without annotated scoring labels to obtain third images; obtaining a first scoring result based on the first images and third images; performing feature extraction based on the first scoring result and the first features to obtain second features, and performing feature fusion based on the second features to obtain fused features; obtaining a second scoring result based on the fused features; extracting multi-scale features of the face images for training, and obtaining a third scoring result based on the third features, the second scoring result, and the multi-scale features; and obtaining a trained face scoring model based on the first scoring result, the second scoring result, and the third scoring result.

### CROSS-REFERENCE TO RELATED APPLICATIONS

This application is a national stage filing under 35 U.S.C. § 371 of international application No. PCT/CN2024/126219, filed Oct. 21, 2024, which claims priority to Chinese patent application No. 2024112075322 filed Aug. 30, 2024. The contents of these applications are incorporated herein by reference in their entirety.

### TECHNICAL FIELD

Embodiments of the present disclosure relate to the field of image recognition technology, and in particular, to a face scoring model training method, a face scoring method, and related devices.

### BACKGROUND

The face scoring technology is a technique that combines image recognition and deep learning to score facial attractiveness based on face images. Face scoring models usually require massive data for training to achieve good performance. In practical applications, there is a problem of insufficient annotated data in training image databases. In addition, complex image features and extended sequential data can also significantly reduce the accuracy and reliability of the face scoring models.

### SUMMARY

The following is a summary of the subject matters described in detail herein. This summary is not intended to limit the scope of protection of the claims.

The present disclosure aims to solve one of the technical problems existing in the prior art at least to a certain extent. Embodiments of the present disclosure provide a face scoring model training method, a face scoring method, and related devices, which can improve the accuracy and reliability of prediction scores.

An embodiment of a first aspect of the present disclosure provides a face scoring model training method, including:
acquiring face images for training, and inputting the face images for training into a face scoring model, the face images for training including first images annotated with scoring labels and second images not annotated with scoring labels;
generating pseudo-labels based on the first images, and assigning the pseudo-labels to the second images to obtain third images annotated with the pseudo-labels;
performing feature extraction based on the first images and the third images to obtain first features, and obtaining a first scoring result based on the first features;
performing feature extraction based on the first scoring result and the first features to obtain second features, and performing feature fusion based on the second features to obtain fused features;
performing feature extraction based on the fused features to obtain third features, and obtaining a second scoring result based on the third features;
extracting multi-scale features of the face images for training, and obtaining a third scoring result based on the third features, the second scoring result, and the multi-scale features; and
adjusting parameters of the face scoring model based on the first scoring result, the second scoring result, and the third scoring result to obtain a trained face scoring model.

According to some embodiments of the first aspect of the present disclosure, the generating pseudo-labels based on the first images includes:
performing weakly supervised learning for a classifier of the face scoring model based on the first images to generate the pseudo-labels.

According to some embodiments of the first aspect of the present disclosure, the assigning the pseudo-labels to the second images to obtain third images annotated with the pseudo-labels includes:
filtering the pseudo-labels based on confidence scores corresponding to the pseudo-labels to obtain filtered pseudo-labels; and
assigning the filtered pseudo-labels to the second images to obtain the third images annotated with the pseudo-labels.

According to some embodiments of the first aspect of the present disclosure, the performing feature extraction based on the first images and the third images to obtain first features, and obtaining a first scoring result based on the first features includes:
performing semi-supervised learning for a classifier of the face scoring model based on the first images and the third images to extract the first features; and
performing classification prediction based on the first features to obtain the first scoring result.

According to some embodiments of the first aspect of the present disclosure, the performing feature extraction based on the first scoring result and the first features to obtain second features, and performing feature fusion based on the second features to obtain fused features includes:
performing convolution based on the first scoring result and the first features to extract the second features;
transforming the second features into a feature space of identical dimensionality; and
performing feature fusion on the transformed second features to obtain the fused features.

According to some embodiments of the first aspect of the present disclosure, the performing feature extraction based on the fused features to obtain third features, and obtaining a second scoring result based on the third features includes:
training a classifier of the face scoring model based on the fused features, and mapping the fused features to class activation maps to obtain the third features; and
performing global max pooling based on the third features to obtain the second scoring result.

According to some embodiments of the first aspect of the present disclosure, the adjusting parameters of the face scoring model based on the first scoring result, the second scoring result, and the third scoring result to obtain a trained face scoring model includes:
obtaining a target scoring result based on a first preset weight parameter, a second preset weight parameter, a third preset weight parameter, the first scoring result, the second scoring result, and the third scoring result;
obtaining a loss function value based on the target scoring result; and
adjusting the parameters of the face scoring model based on the loss function value to obtain the trained face scoring model.

An embodiment of a second aspect of the present disclosure provides a face scoring method, including:
acquiring a face image to be scored; and
inputting the face image to be scored into a trained face scoring model for scoring to obtain a scoring result;
where the trained face scoring model is obtained by training according to the face scoring model training method of the embodiments according to the first aspect of the present disclosure.

An embodiment of a third aspect of the present disclosure provides an electronic device, including a memory and a processor, where the memory stores a computer program which, when executed by the processor, causes the processor to implement the face scoring model training method of the embodiments according to the first aspect of the present disclosure and the face scoring method according to the embodiments of the second aspect of the present disclosure.

An embodiment of a fourth aspect of the present disclosure provides a computer-readable storage medium storing a computer program which, when executed by a processor, causes the processor to implement the face scoring model training method of the embodiments according to the first aspect of the present disclosure and the face scoring method according to the embodiments of the second aspect of the present disclosure.

The above scheme has at least the following beneficial effects. By generating pseudo-labels based on first images annotated with scoring labels, and assigning the pseudo-labels to second images without annotated scoring labels to obtain third images annotated with the pseudo-labels; performing feature extraction based on the first images and the third images to obtain first features, and obtaining a first scoring result based on the first features; performing feature extraction based on the first scoring result and the first features to obtain second features, and performing feature fusion based on the second features to obtain fused features; performing feature extraction based on the fused features to obtain third features, and obtaining a second scoring result based on the third features; extracting multi-scale features of the face images for training, and obtaining a third scoring result based on the third features, the second scoring result, and the multi-scale features; and adjusting parameters of the face scoring model based on the first scoring result, the second scoring result, and the third scoring result to obtain a trained face scoring model, the scoring results are comprehensively weighted and fused, combining the importance and reliability of different features, so that the accuracy and reliability of the target scoring result are ensured.

### BRIEF DESCRIPTION OF DRAWINGS

The accompanying drawings are used to provide further understanding of the technical schemes of the present disclosure and constitute a part of the description. The accompanying drawings are used to explain the technical schemes of the present disclosure together with the embodiments of the present disclosure, and do not constitute a restriction on the technical schemes of the present disclosure.

FIG. 1 is a flowchart of a face scoring method according to an embodiment of the present disclosure;

FIG. 2 is a flowchart of a face scoring model training method according to an embodiment of the present disclosure;

FIG. 3 is a sub-flowchart of generating pseudo-labels based on first images according to an embodiment of the present disclosure;

FIG. 4 is a sub-flowchart of assigning the pseudo-labels to second images to obtain third images annotated with the pseudo-labels according to an embodiment of the present disclosure;

FIG. 5 is a sub-flowchart of step S400 according to an embodiment of the present disclosure;

FIG. 6 is a sub-flowchart of step S500 according to an embodiment of the present disclosure;

FIG. 7 is a sub-flowchart of step S600 according to an embodiment of the present disclosure; and

FIG. 8 is a sub-flowchart of step S800 according to an embodiment of the present disclosure.

### DETAILED DESCRIPTION

In order to make the objectives, technical schemes and advantages of the present disclosure more apparent, the present disclosure is further described in detail in conjunction with the accompanying drawings and embodiments. It should be understood that the particular embodiments described herein are only intended to explain the present disclosure, and are not intended to limit the present disclosure.

It is to be noted that although a functional module division is shown in a schematic diagram of an apparatus and a logical order is shown in a flowchart, the steps shown or described may be executed, in some cases, with a different module division from that of the apparatus or in a different order from that in the flowchart. The terms such as “first” and “second” in the description, claims or above-mentioned drawings are intended to distinguish between similar objects and are not necessarily to describe a specific order or sequence.

The embodiments of the present disclosure will be further explained below with reference to the accompanying drawings.

In an embodiment of the present disclosure, there is provided a face scoring method.

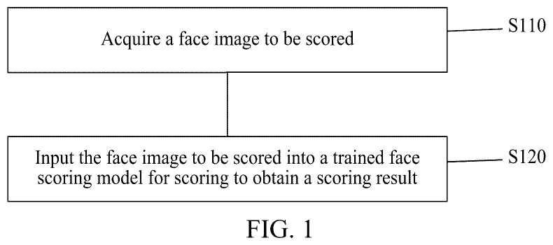

Referring to FIG. 1, the face scoring method includes the following steps.
At S110, a face image to be scored is acquired.
At S120, the face image to be scored is input into a trained face scoring model for scoring to obtain a scoring result.

Herein, the trained face scoring model is obtained by training according to the following face scoring model training method.

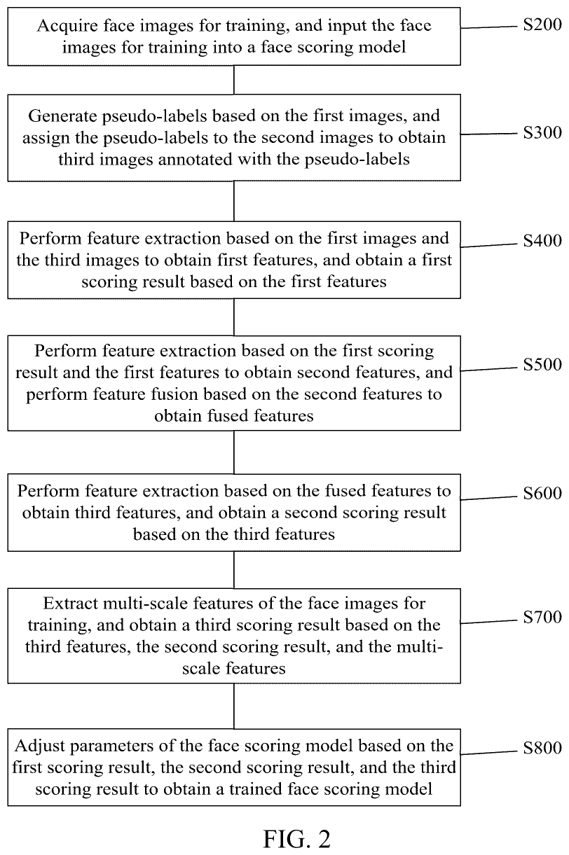

Referring to FIG. 2, the face scoring model training method includes the following steps.
At S200, face images for training are acquired, and the face images for training are input into a face scoring model.
At S300, pseudo-labels are generated based on the first images, and the pseudo-labels are assigned to the second images to obtain third images annotated with the pseudo-labels.
At S400, feature extraction is performed based on the first images and the third images to obtain first features, and a first scoring result is obtained based on the first features.
At S500, feature extraction is performed based on the first scoring result and the first features to obtain second features, and feature fusion is performed based on the second features to obtain fused features.
At S600, feature extraction is performed based on the fused features to obtain third features, and a second scoring result is obtained based on the third features.
At S700, multi-scale features of the face images for training are extracted, and a third scoring result is obtained based on the third features, the second scoring result, and the multi-scale features.
At S800, parameters of the face scoring model are adjusted based on the first scoring result, the second scoring result, and the third scoring result to obtain a trained face scoring model.

In step S200 of some embodiments, the face images for training are acquired. On one hand, face images can be captured through photographic equipment such as cameras and webcams; and on the other hand, face images can be obtained from large online databases.

By manually scoring the beauty of some face images and annotating the scores on the face images, the scoring labels of the face images are obtained, thus obtaining the first images annotated with scoring labels and the second image not annotated with scoring labels. The first images and the second images constitute the dataset of face images for training.

The face images for training are preprocessed with steps such as alignment, data augmentation and standardization. For example, the face images for training are preprocessed with data augmentation techniques such as rotation, scaling, translation, flipping and color transformation to increase the diversity and robustness of the data.

The preprocessed face images for training are then input into the face scoring model.

In step S300 of some embodiments, pseudo-labels are generated based on the first images, and the pseudo-labels are assigned to the second images to obtain third images annotated with the pseudo-labels.

For example, a pre-trained convolutional neural network, such as ResNet-50, is used to extract multi-scale feature maps from the face images for training, where the multi-scale feature maps include feature maps from layers such as Conv3, Conv4, and Conv5.

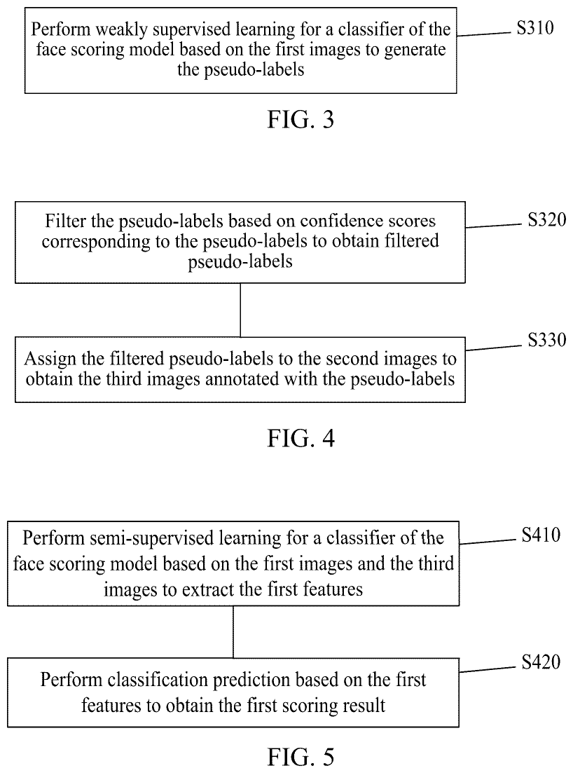

Referring to FIG. 3, the step of generating pseudo-labels based on the first images includes the following steps. At S310, weakly supervised learning is performed for a classifier of the face scoring model based on the first images to generate the pseudo-labels. Specifically, the first images annotated with scoring labels are used to train the classifier of the face scoring model. The trained classifier is used to predict for the second images without annotated scoring labels to generate pseudo-labels. The weakly supervised learning can reduce the costs of image annotation and quickly obtain a large number of annotated images.

Referring to FIG. 4, the step of assigning the pseudo-labels to the second images to obtain third images annotated with the pseudo-labels includes the following steps.
At S320, the pseudo-labels are filtered based on confidence scores corresponding to the pseudo-labels to obtain filtered pseudo-labels.
At S330, the filtered pseudo-labels are assigned to the second images to obtain the third images annotated with the pseudo-labels.

Specifically, the first images annotated with scoring labels are used to train the classifier of the face scoring model. The trained classifier is used to predict for the second images without annotated scoring labels to generate a plurality of pseudo-labels. When generating the pseudo-labels, the confidence probability of each pseudo-label is also generated. The pseudo-labels are filtered based on their corresponding confidence probabilities, and typically, the pseudo-label with the highest confidence score is selected. Each second image without an annotated scoring label is assigned with the class with the highest probability as its pseudo-label. This process can be enhanced by the entropy minimization method, encouraging the model to make low-entropy predictions on unlabeled data, where the lower the entropy of the prediction results, the more accurate they are.

Referring to FIG. 5, in some embodiments, the step S400 of performing feature extraction based on the first images and the third images to obtain first features, and obtaining a first scoring result based on the first features includes the following sub-steps.
At S410, semi-supervised learning is performed for a classifier of the face scoring model based on the first images and the third images to extract the first features.
At S420, classification prediction is performed based on the first features to obtain the first scoring result.

The generated pseudo-labels are used together with the real labels for further training of the model. In each iteration, high-confidence pseudo-label data are selected to be added to the training set, low-confidence prediction results are removed, and the model is updated. The performance of the model trained with pseudo-labels are evaluated. In some methods, the weight of the pseudo-label part can be adjusted through a deterministic simulation process to avoid falling into a local optimum. The above process is iterated continuously until the model performance no longer improves or a predetermined number of iterations is reached. In each iteration, it may be necessary to fine-tune the model to ensure the quality of the pseudo-labels and the generalization ability of the model.

The trained classifier performs feature extraction based on the first images and the third images to obtain the first features, and performs classification prediction based on the first features to obtain the first scoring result.

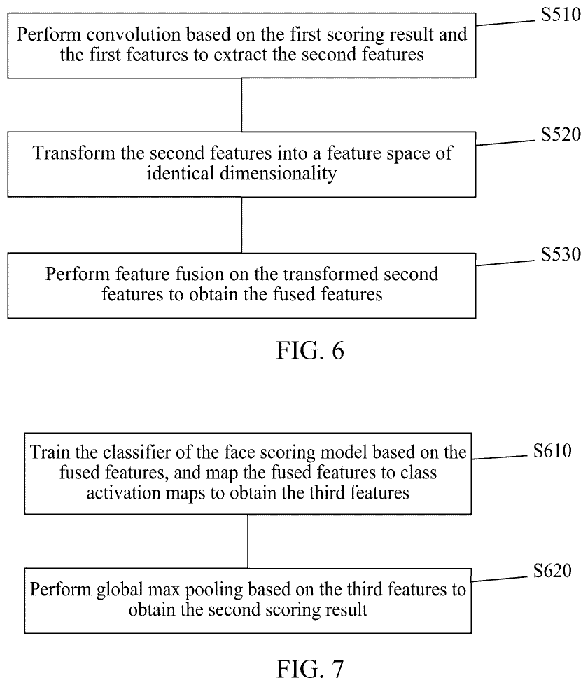

Referring to FIG. 6, in some embodiments, the step S500 of performing feature extraction based on the first scoring result and the first features to obtain second features and performing feature fusion based on the second features to obtain fused features includes the following sub-steps.
At S510, convolution is performed based on the first scoring result and the first features to extract the second features.
At S520, the second features are transformed into a feature space of identical dimensionality.
At S530, feature fusion is performed on the transformed second features to obtain the fused features.

Specifically, convolution is performed using a convolutional neural network based on the first scoring result and the first features to extract the second features. The second features are in different dimensions. To unify the dimensions of the second features, the second features in different dimensions are transformed to a feature space of identical dimensionality through an embedding layer. Feature fusion is performed on the transformed second features using a graph neural network (GNN) to obtain the fused features.

It can be understood that the GNN refers to a neural network that learns graph-structured data, extracts and explores features and patterns in graph-structured data.

Referring to FIG. 7, in some embodiments, the step S600 of performing feature extraction based on the fused features to obtain third features and obtaining a second scoring result based on the third features includes the following sub-steps.
At S610, the classifier of the face scoring model is trained based on the fused features, and the fused features are mapped to class activation maps to obtain the third features.
At S620, global max pooling is performed based on the third features to obtain the second scoring result.

Specifically, the classifier of the face scoring model is trained based on the fused features, and the multi-scale fused features are mapped to the class activation maps through the convolution layer with a 1×1 convolution kernel to obtain the third features. Global max pooling is performed on the third features to extract the feature score of each class, that is, the second scoring result.

The use of class activation maps and global max pooling enhances the interpretability of the model, clearly showing the model's attention to different regions of the image, improving the credibility and visualization effect of the scoring.

Herein, class activation mapping (CAM) is a technique in deep learning used to visualize the decision-making process of convolutional neural networks. It identifies the most critical regions in the image for classification decisions, so as to understand how the model makes classification decisions based on visual or time-series features. The generation of class activation maps is based on the observation that global average pooling simplifies the data but retains spatial or temporal information, which makes it possible to infer the regions that contribute the most to the classification result by backtracking through the feature maps of the convolution layer and the weights of corresponding classes.

Specifically, the fused features are reduced in dimensionality to feature vectors via global average pooling; the feature vectors are multiplied by the weights of the fully connected layer and converted into probabilities through the softmax function. For a specific class, the calculation of the class activation map is achieved by multiplying the weights corresponding to the class from the global average pooling layer to the softmax layer with the activation feature map of the last convolutional layer.

The fusion of multi-scale feature maps and class activation maps via steps S500 and S600 significantly enhances prediction accuracy and generalization ability of the model.

In step S700 of some embodiments, multi-scale features of the face images for training are extracted, and a third scoring result is obtained based on the third features, the second scoring result, and the multi-scale features.

Specifically, the features of the image from different scales and levels are acquired to get multi-scale features, such that various detailed information are captured, including low-level edge features and high-level semantic features, ensuring that the model can fully understand the content of the image. By fusing the third features, the second scoring result and the multi-scale features, the feature information and scoring result are combined, and the complementary relationships between the features are leveraged to enhance scoring accuracy, enabling more precise decision-making. After fusing the third features, the second scoring result and the multi-scale features, the third scoring result is generated through further calculation and analysis, which integrates all feature information and the optimized result, providing a comprehensive and reliable beauty evaluation.

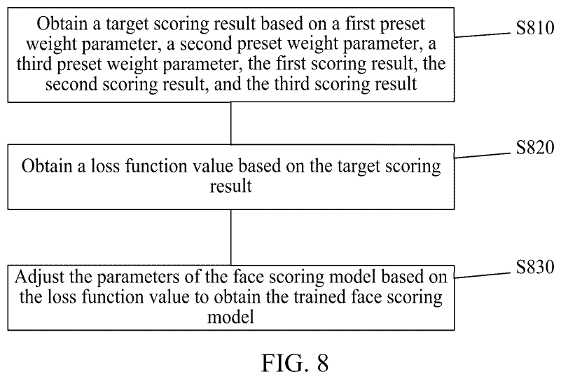

Referring to FIG. 8, in some embodiments, the step S800 of adjusting parameters of the face scoring model based on the first scoring result, the second scoring result, and the third scoring result to obtain a trained face scoring model includes the following sub-steps.
At S810, a target scoring result is obtained based on a first preset weight parameter, a second preset weight parameter, a third preset weight parameter, the first scoring result, the second scoring result, and the third scoring result.
At S820, a loss function value is obtained based on the target scoring result.
At S830, the parameters of the face scoring model are adjusted based on the loss function value to obtain the trained face scoring model.

Specifically, through weight allocation, different weights are assigned according to the importance and reliability of each feature to ensure the reasonable contribution of each feature in the final score. The first preset weight parameter, the second preset weight parameter, and the third preset weight parameter are configured with the first scoring result, the second scoring result, and the third scoring result, respectively. The first preset weight parameter is represented as ω₁, the second preset weight parameter is represented as ω₂, and the third preset weight parameter is represented as ω₃. Moreover, the first preset weight parameter, the second preset weight parameter, and the third preset weight parameter satisfy the following relationship: ω₁+ω₂+ω₃=1. The target scoring result can be represented as: S=ω₁*S₁+ω₂*S₂+ω₃*S₃. Here, S₁ is the first scoring result, S₂ is the second scoring result, and S₃ is the third scoring result.

As the scoring results are comprehensively weighted and fused, combining the importance and reliability of different features, the accuracy and reliability of the target scoring result are ensured.

In an embodiment of the present disclosure, there is provided an electronic device. The electronic device includes: a memory, a processor, and a computer program stored in the memory and executable by the processor, where the computer program, when executed by the processor, causes the processor to perform the face scoring model training method and the face scoring method as described above.

The electronic device may be any intelligent terminal device, including computers or the like.

Generally speaking, for the hardware structure of the electronic device, the processor may be implemented by a general-purpose central processing unit (CPU), a microprocessor, an application-specific integrated circuit (ASIC), or one or more integrated circuits, and is used for executing related programs to implement the technical schemes provided by the embodiments of the present disclosure.

The memory may be implemented in forms such as a read-only memory (ROM), a static storage device, a dynamic storage device, or a random access memory (RAM). The memory may store an operating system and other applications, and when the technical schemes provided by the embodiments of the present specification are implemented by software or firmware, the related program code is stored in the memory and is called and executed by the processor to perform the method of the embodiments of the present disclosure.

An input/output interface is used to realize the input and output of information.

A communication interface is used to realize the communication and interaction between this device and other devices, and can realize the communication through wired methods (such as USB, network cables, etc.) or wireless methods (such as mobile networks, Wi-Fi, Bluetooth, etc.).

A bus transmits information between various components (such as the processor, memory, input/output interface, and communication interface) of the device. The processor, the memory, the input/output interface, and the communication interface communicate with each other within the device via the bus.

In an embodiment of the present disclosure, there is provided a computer-readable storage medium. The computer-readable storage medium stores computer-executable instructions configured to cause a computer to execute the face scoring model training method and the face scoring method as described above.

It can be understood by those of ordinary skill in the art that all or some of the steps of the methods and systems disclosed above may be implemented as software, firmware, hardware, and appropriate combinations thereof. Some or all of the physical components may be implemented as software executed by a processor, such as a central processing unit, a digital signal processor or a microprocessor, or as hardware, or as an integrated circuit, such as an application-specific integrated circuit. Such software may be distributed on computer-readable media, which may include computer-readable storage media (or non-transitory media) and communication media (or transitory media). As well known to those of ordinary skill in the art, the term computer-readable storage medium includes volatile and nonvolatile, removable and non-removable media implemented in any method or technique for storing information, such as computer-readable instructions, data structures, program modules or other data. A computer-readable storage medium includes but is not limited to a random access memory (RAM), a read-only memory (ROM), an electrically erasable programmable read-only memory (EEPROM), a flash memory or other memory techniques, a compact disc read-only memory (CD-ROM), a digital versatile disk (DVD) or other optical disk storage, a magnetic cassette, a magnetic tape, magnetic disk storage or other magnetic storage devices, or any other medium that can be used to store desired information and can be accessed by a computer. Furthermore, it is well known to those of ordinary skill in the art that communication media typically contain computer-readable instructions, data structures, program modules or other data in a modulated data signal such as a carrier wave or other transmission mechanism, and may include any information transmission media. In the foregoing description, the explanation with reference to the terms “an implementation/embodiment”, “another implementation/embodiment” or “some implementations/embodiments”, etc. means that specific features, structures, materials or characteristics described in connection with the embodiment(s) or example(s) are included in at least one embodiment or example of the present disclosure. In the description, the illustrative expressions of the above-mentioned terms do not necessarily refer to the same embodiments or examples. Moreover, the specific features, structures, materials or characteristics described can be combined in any one or more embodiments or examples in any suitable manner.

It can be understood by those of ordinary skill in the art that all or some of the steps of the methods, systems and functional modules/units in the devices disclosed above can be implemented as software, firmware, hardware and appropriate combinations thereof.

The above units described as separate components may or may not be physically separated, and the components displayed as units may or may not be physical units, that is, they may be located in one place or distributed to multiple network units. Some or all of the units can be selected according to actual needs to achieve the objective of the embodiment.

In addition, the functional units in each embodiment of the present disclosure may be integrated into one processing unit, or each unit may be physically separate, or two or more units may be integrated into one unit. The integration unit can be realized either in the form of hardware or in the form of a software functional unit.

If the integrated units are implemented in the form of functional units of software and sold or used as independent products, they can be stored in a computer-readable storage medium. On the basis of such understanding, the substance or the parts that contribute to the existing technology or all or a part of the technical schemes of the present disclosure may be embodied in the form of a software product, which is stored in a storage medium and includes a number of instructions to cause a computer device (which can be a personal computer, a server, or a network device, etc.) to execute all or some of the steps of the method described in the embodiments of the present disclosure. The aforementioned storage medium includes: various media that can store program codes, such as a USB flash drive, a mobile hard disk, a read-only memory (ROM), a random access memory (RAM), a magnetic disk or an optical disk.

In the embodiments provided by the present disclosure, it should be understood that the disclosed device and method can be realized in alternative ways. For example, the device embodiments described above are only for illustration. For example, the division of the units is only a logic function division. In actual implementation, there may be alternative manners for the division, for example, multiple units or components may be combined or integrated into another system, or some features may be omitted or not implemented. Further, the mutual coupling or direct coupling or communication connection shown or discussed may be indirect coupling or communication connection through some interfaces, devices or units, and may be in electrical, mechanical or other forms. Although the embodiments of the present disclosure have been shown and described, it can be understood by those of ordinary skill in the art that various changes, modifications, substitutions and variations may be made to these embodiments without departing from the principles and objectives of the present disclosure, and the scope of the present disclosure is defined by the claims and their equivalents.

The above is a detailed description of the preferred implementation of the present disclosure, but the present disclosure is not limited to the embodiments described above. Those of ordinary skill in the art can make various equivalent modifications or replacements without departing from the gist of the present disclosure, and these equivalent modifications or replacements are all included in the scope defined by the claims of the present disclosure.

1. A face scoring model training method, comprising:
acquiring face images for training, and inputting the face images for training into a face scoring model, the face images for training comprising first images annotated with scoring labels and second images not annotated with scoring labels;
generating pseudo-labels based on the first images, and assigning the pseudo-labels to the second images to obtain third images annotated with the pseudo-labels;
performing feature extraction based on the first images and the third images to obtain first features, and obtaining a first scoring result based on the first features;
performing feature extraction based on the first scoring result and the first features to obtain second features, and performing feature fusion based on the second features to obtain fused features;
performing feature extraction based on the fused features to obtain third features, and obtaining a second scoring result based on the third features;
extracting multi-scale features of the face images for training, and obtaining a third scoring result based on the third features, the second scoring result, and the multi-scale features; and
adjusting parameters of the face scoring model based on the first scoring result, the second scoring result, and the third scoring result to obtain a trained face scoring model.

2. The face scoring model training method of claim 1, wherein the generating pseudo-labels based on the first images comprises:
performing weakly supervised learning for a classifier of the face scoring model based on the first images to generate the pseudo-labels.

3. The face scoring model training method of claim 1, wherein the assigning the pseudo-labels to the second images to obtain third images annotated with the pseudo-labels comprises:
filtering the pseudo-labels based on confidence scores corresponding to the pseudo-labels to obtain filtered pseudo-labels; and
assigning the filtered pseudo-labels to the second images to obtain the third images annotated with the pseudo-labels.

4. The face scoring model training method of claim 1, wherein the performing feature extraction based on the first images and the third images to obtain first features, and obtaining a first scoring result based on the first features comprises:
performing semi-supervised learning for a classifier of the face scoring model based on the first images and the third images to extract the first features; and
performing classification prediction based on the first features to obtain the first scoring result.

5. The face scoring model training method of claim 1, wherein the performing feature extraction based on the first scoring result and the first features to obtain second features, and performing feature fusion based on the second features to obtain fused features comprises:
performing convolution based on the first scoring result and the first features to extract the second features;
transforming the second features into a feature space of identical dimensionality; and
performing feature fusion on the transformed second features to obtain the fused features.

6. The face scoring model training method of claim 1, wherein the performing feature extraction based on the fused features to obtain third features, and obtaining a second scoring result based on the third features comprises:
training a classifier of the face scoring model based on the fused features, and mapping the fused features to class activation maps to obtain the third features; and
performing global max pooling based on the third features to obtain the second scoring result.

7. The face scoring model training method of claim 1, wherein the adjusting parameters of the face scoring model based on the first scoring result, the second scoring result, and the third scoring result to obtain a trained face scoring model comprises:
obtaining a target scoring result based on a first preset weight parameter, a second preset weight parameter, a third preset weight parameter, the first scoring result, the second scoring result, and the third scoring result;
obtaining a loss function value based on the target scoring result; and
adjusting the parameters of the face scoring model based on the loss function value to obtain the trained face scoring model.

8. A face scoring method, comprising:
acquiring a face image to be scored; and
inputting the face image to be scored into a trained face scoring model for scoring to obtain a scoring result;
wherein the trained face scoring model is obtained by training according to the face scoring model training method of claim 1.

9. An electronic device, comprising a memory and a processor, wherein the memory stores a computer program which, when executed by the processor, causes the processor to implement the face scoring model training method of claim 1.

10. A non-transitory computer-readable storage medium storing a computer program, wherein the computer program, when executed by a processor, causes the processor to implement the face scoring model training method of claim 1.

11. An electronic device, comprising a memory and a processor, wherein the memory stores a computer program which, when executed by the processor, causes the processor to implement the face scoring model training method of claim 8.

12. A non-transitory computer-readable storage medium storing a computer program, wherein the computer program, when executed by a processor, causes the processor to implement the face scoring model training method of claim 8.
